(19) United States
(12) Patent Application Publication
(10) Pub. No.: US 2026/0281767 A1
(43) Pub. Date: Sep. 17, 2026

(54) DEVICES AND METHODS FOR RELIABLE COMMUNICATION IN A WIRELESS NETWORK

(71) Applicant: HUAWEI TECHNOLOGIES CO., LTD., Shenzhen (CN)

(72) Inventors: Shimon Shilo, Hod Hasharon (IL); Rani Keren, Hod Hasharon (IL); Arik Klein, Hod Hasharon (IL); Doron Ezri, Hod Hasharon (IL); Genadiy Tsodik, Hod Hasharon (IL)

(73) Assignee: HUAWEI TECHNOLOGIES CO., LTD., Shenzhen (CN)

(21) Appl. No.: 19/675,762

(22) Filed: May 13, 2026

Related U.S. Application Data
(63) Continuation of application No. PCT/EP2023/081651, filed on Nov. 13, 2023.

(51) Int. Cl. H04W 24/08

(52) U.S. Cl. CPC H04W 24/08

(57) ABSTRACT

A wireless transmitter station for communication with at least one wireless receiver station over a wireless communication channel in a wireless communication network, where the wireless transmitter station is configured to transmit a sounding signal to the at least one wireless receiver station. The at least one wireless receiver station is configured to determine, based on the sounding signal, a channel quality metric according to a plurality of determination modes. The wireless transmitter station is configured to transmit an indication to the at least one wireless receiver station, where the indication is indicative of one of the plurality of determination modes of the at least one wireless receiver station.

### CROSS-REFERENCE TO RELATED APPLICATIONS

This application is a continuation of International Patent Application No. PCT/EP2023/081651, filed on Nov. 13, 2023, the disclosure of which is hereby incorporated by reference in its entirety.

### FIELD

The present disclosure relates to wireless communications and embodiments of the present disclosure relate to devices, such as access points (APs) and non-AP stations, and methods for reliable communication in a wireless communication network, such as a Wi-Fi network, i.e. a wireless communication network according to the IEEE 802.11 framework of standards.

### BACKGROUND

IEEE 802.11-based Wireless Local Area Networks (WLANs) (also referred to as Wi-Fi networks) have become popular at an unprecedented rate. One important aspect of a Wi-Fi network is its reliability, such as the Ultra High Reliability (UHR) requirement. There has been a suggestion to improve the reliability of communication in a Wi-Fi network by using in a sounding mechanism additional pilot signals (referred to as interference mitigation (IM) pilots) which allow a receiver to mitigate any interference (<<https://mentor.ieee.org/802.11/dcn/23/11-23-1490-00-0uhr-physical-layer-reliability-improvements.pptx>>). Based on the IM pilots this interference mitigation may be achieved by the receiver, for instance, by processing the received signals with a Minimum Variance Distortionless Response (MVDR) detector, i.e. demodulator instead of a Maximal Ratio Combining (MRC) detector, i.e. demodulator.

### SUMMARY

Embodiments of the present disclosure provide improved devices, in particular access points and non-AP stations, and methods for reliable communication in a wireless network, in particular a Wi-Fi network, i.e. a wireless communication network according to the IEEE 802.11 framework of standards.

According to a first aspect a wireless transmitter station for communication with at least one wireless receiver station over a wireless communication channel with noise and interference in a wireless communication network is provided. The wireless transmitter station is configured to transmit a sounding signal to the at least one wireless receiver station, wherein the at least one wireless receiver station is configured to determine, based on the received sounding signal, a channel quality metric according to a plurality of selectable channel quality metric determination modes. Moreover, the wireless transmitter station is configured to transmit an indication to the at least one wireless receiver station, wherein the indication is indicative of one of the plurality of selectable channel quality metric determination modes of the at least one wireless receiver station. Thus, the wireless transmitter station according to the first aspect may instruct the wireless receiver station(s) to select an advantageous channel quality metric determination mode. In an implementation form, the wireless transmitter station may be configured to transmit the indication before, concurrently with or after the sounding signal. In an implementation form, the indication may be part of the sounding signal.

In a further possible implementation form, according to a first determination mode of the plurality of determination modes the at least one wireless receiver station is configured to determine the channel quality metric without using interference mitigation and according to a second determination mode of the plurality of determination modes the at least one wireless receiver station is configured to determine the channel quality metric using interference mitigation, wherein the indication is indicative of the first determination mode or the second determination mode.

In a further possible implementation form, the channel quality metric is a Signal to Noise Ratio (SNR) or a Signal to Interference and Noise Ratio (SINR).

In a further possible implementation form, the wireless transmitter station is configured to transmit a Sounding null data Physical Layer Protocol Data Unit (PPDU) (Null Data PPDU (NDP)), and an NDP announcement (NDPA) frame to the at least one wireless receiver station, wherein the Sounding NDP comprises the sounding signal and wherein the NDPA frame comprises the indication.

In a further possible implementation form, the indication comprises a bit or a bit sequence.

In a further possible implementation form, the wireless transmitter station is configured to receive a sounding feedback report frame from each of the at least one wireless receiver station, wherein the sounding feedback report frame received from a specific receiver station comprises a further indication indicative of the determination mode used by the at least one wireless receiver station for determining the channel quality metric.

In a further possible implementation form, the reception of the sounding feedback report frame from more than a single wireless receiver station is preceded with a trigger frame soliciting the reception of the sounding feedback report frame from two or more specific wireless receiver stations.

In a further possible implementation form, the sounding feedback report frame comprises a multiple input multiple output (MIMO) control field and the MIMO control field comprises the further indication.

In a further possible implementation form, the further indication comprises a bit or a bit sequence.

In a further possible implementation form, the sounding feedback report frame further comprises information representative of the channel quality metric determined by the at least one wireless receiver station.

In a further possible implementation form, the channel quality metric is a Signal to Interference and Noise Ratio (SINR) and the information representative of the SINR determined by the at least one wireless receiver station comprises an explicit value of the SINR and/or a value of the SINR relative to a signal-to-noise-ratio (SNR) determined by the at least one wireless receiver station, wherein the at least one wireless receiver station is configured to determine the SNR without using interference mitigation.

In a further possible implementation form, the wireless communication network is a Wi-Fi network and the wireless transmitter station is an access point (AP) or a non-AP station according to the IEEE 802.11 framework of standards.

According to a second aspect a method of operating a wireless transmitter station for communication with at least one wireless receiver station over a wireless communication channel with noise and interference in a wireless communication network is provided. The method comprises the steps of: transmitting an indication to the at least one wireless receiver station, wherein the indication is indicative of one of a plurality of selectable channel quality metric determination modes of the at least one wireless receiver station; and transmitting a sounding signal to the at least one wireless receiver station, wherein the at least one wireless receiver station is configured to determine, based on the received sounding signal, a channel quality metric according to the indicated, i.e. selected channel quality metric determination mode of the plurality of selectable channel quality metric determination modes.

The method according to the second aspect can be performed by the wireless transmitter station according to the first aspect. Thus, further features of the method according to the second aspect result directly from the functionality of the wireless transmitter station according to the first aspect as well as its different implementation forms described above and below.

According to a third aspect a wireless receiver station for communication with a wireless transmitter station over a wireless communication channel with noise and interference in a wireless communication network is provided. The wireless receiver station is configured to receive a sounding signal from the wireless transmitter station, wherein the wireless receiver station is configured to determine, based on the received sounding signal, a channel quality metric according to a plurality of selectable channel quality metric determination modes. Moreover, the wireless receiver station is configured to receive an indication from the wireless transmitter station, wherein the indication is indicative of one of the plurality of selectable channel quality metric determination modes. Thus, the wireless transmitter station may instruct the wireless receiver station according to the third aspect to select an advantageous channel quality metric determination mode. In an implementation form, the wireless receiver station may be configured to receive the indication before, concurrently with or after the sounding signal. In an implementation form, the indication may be part of the sounding signal.

In a further possible implementation form, according to a first determination mode of the plurality of determination modes the wireless receiver station is configured to determine the channel quality metric without using interference mitigation and according to a second determination mode of the plurality of determination modes the wireless receiver station is configured to determine the channel quality metric using interference mitigation, wherein the indication is indicative of the first determination mode or the second determination mode.

In a further possible implementation form, according to the first determination mode the wireless receiver station is configured to determine the channel quality metric without using interference mitigation by using a maximal ratio combining (MRCO detector.

In a further possible implementation form, according to the second determination mode the wireless receiver station is configured to determine the channel quality metric using interference mitigation by using a minimum variance distortionless response (MVDR) detector.

In a further possible implementation form, the wireless receiver station comprises a plurality of receiving antennas and wherein according to the second determination mode the wireless receiver station is configured to determine the channel quality metric using interference mitigation by using a reduced number of the plurality of receiving antennas.

In a further possible implementation form, the channel quality metric is a SNR or a SINR.

In a further possible implementation form, the wireless receiver station is configured to receive an NDP announcement (NDPA) frame and a Sounding null data PPDU, NDP, from the wireless transmitter station, wherein the Sounding NDP comprises the sounding signal and wherein the NDPA frame comprises the indication.

In a further possible implementation form, the indication comprises a bit or a bit sequence.

In a further possible implementation form, the wireless receiver station is configured to transmit a sounding feedback report frame to the wireless transmitter station, wherein the sounding feedback report frame comprises a further indication indicative of the determination mode used by the wireless receiver station for determining the channel quality metric.

In a further possible implementation form, the wireless receiver station is configured to transmit the sounding feedback report frame to the wireless transmitter station, in response to receiving from the wireless transmitter station a trigger frame soliciting the transmission of the sounding feedback report frame from two or more specific wireless receiver stations.

In a further possible implementation form, the sounding feedback report frame comprises a MIMO control field and the MIMO control field comprises the further indication.

In a further possible implementation form, the further indication in the MIMO control field comprises a bit or a bit sequence.

In a further possible implementation form, the sounding feedback report frame further comprises information representative of the channel quality metric determined by the wireless receiver station.

In a further possible implementation form, the channel quality metric is a SINR, and the information representative of the SINR determined by the wireless receiver station comprises an explicit value of the SINR and/or a value of the SINR relative to a SNR determined by the wireless receiver station, wherein the wireless receiver station is configured to determine the SNR without using interference mitigation.

In a further possible implementation form, the wireless communication network is a Wi-Fi network and the wireless receiver station is an AP, or a non-AP station according to the IEEE 802.11 framework of standards.

According to a fourth aspect a method of operating a wireless receiver station for communication with a wireless transmitter station over a wireless communication channel with noise and interference in a wireless communication network is provided. The method comprises the steps of: receiving an indication from the wireless transmitter station, wherein the indication is indicative of one of a plurality of selectable channel quality metric determination modes of the wireless receiver station; and receiving a sounding signal from the wireless transmitter station, wherein the wireless receiver station is configured to determine, based on the received sounding signal, a channel quality metric according to the indicated, i.e. selected channel quality metric determination mode of the plurality of selectable channel quality metric determination modes.

The method according to the fourth aspect can be performed by the wireless receiver station according to the third aspect. Thus, further features of the method according to the fourth aspect result directly from the functionality of the wireless receiver station according to the third aspect as well as its different implementation forms described above and below.

According to a fifth aspect a computer program product is provided, comprising program code which causes a computer or a processor to perform the method according to the second aspect or the method according to the fourth aspect, when the program code is executed by the computer or the processor.

Details of one or more embodiments are set forth in the accompanying drawings and the description below. Other features, objects, and advantages will be apparent from the description, drawings, and present disclosure.

### BRIEF DESCRIPTION OF THE DRAWINGS

In the following, embodiments of the present disclosure are described in more detail with reference to the attached figures and drawings, in which:

FIG. 1 shows a schematic diagram illustrating a wireless communication network, in particular a Wi-Fi network including a wireless transmitter station according to an embodiment in communication with a plurality of wireless receiver stations according to an embodiment of the present disclosure;

FIG. 2 shows a flow diagram illustrating steps of a method according to an embodiment for operating a wireless transmitter station according to an embodiment of the present disclosure; and

FIG. 3 shows a flow diagram illustrating steps of a method according to an embodiment for operating a wireless receiver station according to an embodiment of the present disclosure.

In the following, identical reference signs refer to identical or at least functionally equivalent features.

### DETAILED DESCRIPTION

In the following description, reference is made to the accompanying figures, which form part of the present disclosure, which illustrate specific aspects of embodiments of the present disclosure or specific aspects in which embodiments of the present disclosure may be used. It is understood that embodiments of the present disclosure may be used in other aspects and comprise structural or logical changes not depicted in the figures. The following detailed description, therefore, is not to be taken in a limiting sense.

For instance, it is to be understood that a disclosure in connection with a described method may also hold true for a corresponding device or system configured to perform the method and vice versa. For example, if one or a plurality of specific method steps are described, a corresponding device may include one or a plurality of units, e.g. functional units, to perform the described one or plurality of method steps (e.g. one unit performing the one or plurality of steps, or a plurality of units each performing one or more of the plurality of steps), even if such one or more units are not explicitly described or illustrated in the figures. On the other hand, for example, if a specific apparatus is described based on one or a plurality of units, e.g. functional units, a corresponding method may include one step to perform the functionality of the one or plurality of units (e.g. one step performing the functionality of the one or plurality of units, or a plurality of steps each performing the functionality of one or more of the plurality of units), even if such one or plurality of steps are not explicitly described or illustrated in the figures. Further, it is understood that the features of the various exemplary embodiments and/or aspects described herein may be combined with each other, unless specifically noted otherwise.

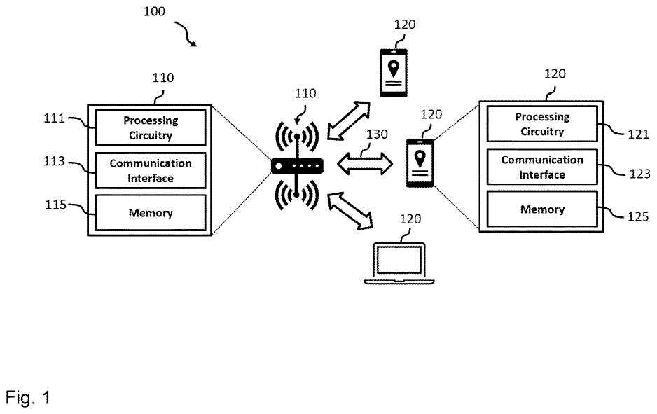

FIG. 1 shows a wireless communication network 100, in particular a wireless communication network in accordance with the IEEE 802.11 framework of standards (also referred to as a Wi-Fi network 100). The Wi-Fi network 100 comprises a wireless transmitter station 110 (also referred to as Wi-Fi station 110 herein), which may be implemented in the form of a multi-antenna AP 110, and a plurality of wireless receiver stations 120 (also referred to as further Wi-Fi stations 120 herein) in the form of, for instance, non-AP stations 120. As illustrated in FIG. 1, by way of example, the non-AP stations 120 may comprise smartphones, laptop computers, tablet computers, desktop computers or other types of wireless devices 120. In the following several embodiments of the AP 110 as wireless transmitter station 110 and the non-AP stations 120 as wireless receiver stations 120 will be described in more detail below. As will be appreciated, however, the AP 110 may be implemented as a wireless receiver station and each of the non-AP stations 120 may be implemented as a wireless transmitter station as well in accordance with the following embodiments.

As further illustrated in FIG. 1, the AP 110 may comprise a processing circuitry 111 and a communication interface 113, in particular a wireless communication interface 113, e.g. a transceiver 113 enabling communication in accordance with the IEEE 802.11 framework of standards over a channel 130. In an embodiment of the present disclosure, the wireless communication interface 113 may be configured to use beamforming for communicating with the wireless receiver stations 120. The processing circuitry 111 of the wireless transmitter station 110 may be implemented in hardware and/or software and may comprise digital circuitry, or both analog and digital circuitry. Digital circuitry may comprise components such as application-specific integrated circuits (ASICs), field-programmable gate arrays (FPGAs), digital signal processors (DSPs), or general-purpose processors. The AP 110 may further comprise a memory 115 configured to store executable program code which, when executed by the processing circuitry 111, causes the AP 110 to perform the functions and methods described herein.

Likewise, as indicated in FIG. 1, each of the non-AP stations 120 may comprise a processing circuitry 121 and a communication interface 123, in particular a wireless communication interface 123, e.g. a transceiver 123 enabling communication in accordance with the IEEE 802.11 framework of standards over the channel 130. In an embodiment of the present disclosure, the wireless communication interface 123 may be configured to use beamforming for communicating with the wireless transmitter station 110. The processing circuitry 121 of each wireless receiver station 120 may be implemented in hardware and/or software and may comprise digital circuitry, or both analog and digital circuitry. Digital circuitry may comprise components such as application-specific integrated circuits (ASICs), field-programmable gate arrays (FPGAs), digital signal processors (DSPs), or general-purpose processors. Each non-AP station 120 may further comprise a memory 125 configured to store executable program code which, when executed by the processing circuitry 121, causes the non-AP station 120 to perform the functions and methods described herein.

Before describing different embodiments of the wireless transmitter station 110, e.g. the AP 110, and the wireless receiver station(s) 120, e.g. the non-AP station(s) 120, in more detail, in the following some technical background as well as terminology will be introduced making use of one or more of the following abbreviations:
AP Access Point
AWGN Additive White Gaussian Noise
BW Bandwidth
BFR Beamforming Report
CQI Channel Quality Information
EHT Extremely High Efficiency
HE High Efficiency
IEEE Institute of Electrical and Electronics Engineers
IM Interference Mitigation
MCS Modulation and Coding Scheme (Rate)
MIMO Multiple Input Multiple Output
MRC Maximal Ratio Combining
MVDR Minimum Variance Distortion-less Response
NDP Null Data PPDU
NDPA Null Data Packet Announcement
OFDM/A Orthogonal Frequency Division Multiplexing/Multiple-Access
PER Packet Error Rate
PPDU Physical Layer Protocol Data Unit
PPSNR Post-Processing Signal to Noise Ratio
PPSINR Post-Processing Signal to Interference Ratio
QAM Quadrature Amplitude Modulation
RU Resource Unit
SNR Signal to Noise power Ratio
SIR Signal to Interference power Ratio
STA Station, may be an AP STA or a non-AP STA
UHR Ultra High Reliability
U-SIG Universal signal field
VHT Very High Throughput

Embodiments disclosed herein relate to the impact of using IM pilots in a Wi-Fi sounding mechanism, in particular the UHR NDP sounding mechanism and how the (post-processing) SINR measurement may reflect the use of IM techniques. Generally, the standardized NDP sounding mechanism may be used for two major purposes, namely for SNR/SINR measurement (CQI) and for beamforming. For the SNR/SINR measurement (CQI) the Signal to Noise or Signal to Interference and Noise ratio is measured by the receiver over a certain frequency subchannel, which is computed per RU, and then fed back. For beamforming both the precoder and the corresponding SNR/SINR are computed by the receiver and fed back (average and per-tone, if required). In both of these cases, there is no definition of what demodulator is assumed for the SINR measurement, although usually a linear (e.g. MRC) detector/demodulator is used. This is important because an MRC detector/demodulator is not capable of taking any (potential) interference into account when trying to estimate the transmitted QAM symbols.

A signal from the wireless transmitter station 110 received by the wireless receiver station(s) 120 under the influence of noise and interference may be described in the following way:

$$y = hs + gr + ρ n ,$$

wherein y denotes the received signal, h denotes the channel of the desired signal s, g denotes the channel of the interference signal r, n denotes an additive white Gaussian noise, AWGN, channel and p denotes the noise intensity, which satisfies ρ²=1/SNR, wherein SNR denotes the signal-to-noise ratio. The covariance matrix C taking into account noise and interference may be expressed as follows:

$$C = E [ ( y - hs ) {( y - hs )}^{*} ] = {ρ}^{2} I + {gg}^{*} ,$$

wherein E[ ] denotes the expectation value, I denotes the unity matrix and * denotes the complex conjugate operation. As will be appreciated, the covariance depends on the noise and the interference.

An MRC detector, which ignores the interference, performs the following operation to estimate the transmitted symbol:

$${\hat{s}}_{MRC} = \frac{h * y}{{‖ h ‖}^{2}} .$$

A MVDR detector, which is an example for a detector that does consider the interference, performs the following operation to estimate the transmitted symbol:

$${\hat{s}}_{MVDR} = \frac{h * {C}^{- 1} y}{h * {C}^{- 1} h} .$$

As will be appreciated, when there is no interference, the covariance of the noise and interference becomes C=ρ²I and in this case ŝ_{MVDR}=ŝ_{MRC}.

For communicating with the one or more wireless receiver stations 120 the wireless transmitter station 110 of FIG. 1 is configured to transmit a sounding signal to the one or more wireless receiver stations 120. In an embodiment, the wireless transmitter station 110 is configured to transmit a Sounding null data PPDU (NDP) to the one or more wireless receiver stations 120, wherein the Sounding NDP comprises or constitutes the sounding signal. In an embodiment of the present disclosure, the wireless transmitter station 110 is configured to transmit a Sounding NDP in accordance with the IEEE 802.11 framework of standards to the one or more wireless receiver stations 120.

As will be described in more detail below, each wireless receiver station 120 is configured to determine, based on the sounding signal received from the wireless transmitter station 110, a channel quality metric according to a plurality of selectable channel quality metric determination modes. In an embodiment of the present disclosure, the channel quality metric may be, for instance, the SNR, or the SINR. In an embodiment of the present disclosure, each wireless receiver station 120 may determine the SINR and the interference by determining the covariance of the interference over time and use the interference for the SINR measurement (because a Sounding NDP might not be interfered, whereas a data PPDU, which is longer, might be interfered with higher probability).

In addition to the sounding signal the wireless transmitter station 110 is further configured to send an indication to the one or more wireless receiver stations 120, wherein the indication is indicative of one of the plurality of selectable channel quality metric determination modes of each wireless receiver station 120. As will be appreciated, by means of the indication provided to each wireless receiver station 120 the wireless transmitter station 110 may request each wireless receiver station 110 to use a specific, i.e. selected channel quality metric determination modes of the plurality of selectable channel quality metric determination modes for determining the channel quality metric, e.g. the SNR and/or SINR, based on the received sounding signal. In an embodiment of the present disclosure, the wireless transmitter station 110 may be configured to transmit the indication before, concurrently with or after the sounding signal to the one or more wireless receiver stations 120. In an implementation form, the indication may be part of the sounding signal.

In an embodiment of the present disclosure, the wireless transmitter station 110 is configured to transmit an NDPA frame in addition to a Sounding NDP to the one or more wireless receiver stations 120, wherein the NDPA frame comprises the indication indicative of one of the plurality of selectable channel quality metric determination modes of the respective wireless receiver station 120. As will be appreciated, the indication within the NDPA frame may be relevant for both CQI feedback as well as Beamforming Report (BFR) feedback. In an embodiment, the indication may comprise a single bit for distinguishing between two different determination modes or a bit sequence for distinguishing between more than two different determination modes.

In an embodiment of the present disclosure, according to a first channel quality metric determination mode of the plurality of channel quality metric determination modes each wireless receiver station 120 is configured to determine the channel quality metric without using interference mitigation and according to a second channel quality metric determination mode of the plurality of channel quality metric determination modes each wireless receiver station 120 is configured to determine the channel quality metric using interference mitigation. In other words, in an embodiment of the present disclosure, each wireless receiver station 120 may be configured to determine the channel quality metric, in particular the SNR and/or SINR, based on the sounding signal either with or without taking interference into account. In such an embodiment, the indication provided by the wireless transmitter station 110 may be indicative of one of these two different channel quality metric determination modes.

In an embodiment of the present disclosure, the wireless receiver station(s) 120 may comprise a plurality of antennas, for instance, for beamforming communication with the wireless transmitter station 110. In such an embodiment, the wireless receiver station(s) is configured according to the second determination mode to determine the channel quality metric using interference mitigation by using a reduced number of the plurality of antennas. Thus, in this embodiment, instead of instructing the wireless receiver station 120 (e.g. the beamformee) to compute the SINR assuming (or corresponding to the application of) an interference mitigation demodulator, the wireless transmitter station 110 may instruct the wireless receiver station 120 (e.g. the beamformee) to simply reduce the number of receive antennas for its SINR computation. This may be applicable if no interference is experienced during the UHR Sounding NDP (so SINR computation assuming interference will not reflect true performance). As will be appreciated, an interference mitigation demodulator effectively reduces the number of available Rx antennas (for data demodulation), because one or more Rx antennas will effectively be used for mitigating the interference and the remaining Rx antennas will be used for demodulating the data. In this embodiment, the indication in the form of a single bit may indicate to the wireless receiver station 120 to reduce number of Rx antennas by one when computing the post-processing SINR. In order to reduce more than one antenna, the wireless transmitter station 110 should know how many Rx antennas the wireless receiver station 120 is equipped with. Since usually the number of Rx antennas isn't known to the wireless transmitter station 110, but rather the maximum number of supported spatial streams, in an embodiment of the present disclosure, the wireless transmitter station 110 may use the maximum number of supported streams N_SS. In an embodiment of the present disclosure, 1 or 2 more bits may be used as the indication to indicate how many Rx antennas to reduce from the post-processing SINR computation, assuming N_Rx>=N_SS and provided that the number of RX antennas used for the computation, after the reduction, will be greater than or equal to the value of N_SS.

In an embodiment of the present disclosure, the wireless transmitter station 110 is configured to receive a sounding feedback report frame from each wireless receiver station 120. In an embodiment of the present disclosure, the sounding feedback report frame received from each wireless receiver station 120 may comprise a further indication indicative of the channel quality metric determination mode actually used by the respective wireless receiver station 120 for determining the channel quality metric based on the Sounding NDP. In an embodiment of the present disclosure, the sounding feedback report frame comprises a MIMO control field and the MIMO control field comprises the further indication. In an embodiment of the present disclosure, the further indication may comprise a single bit for distinguishing between two different determination modes or a bit sequence for distinguishing between more than two different determination modes.

In an embodiment of the present disclosure, the reception of the sounding feedback report frame from the wireless receiver stations 120 may be preceded by a trigger frame soliciting the reception of the sounding feedback report frame from two or more specific stations of the wireless receiver stations 120. In other words, in an embodiment of the present disclosure, the wireless transmitter station 110 is configured to send a trigger frame to the two or more wireless receiver station(s) 120 for soliciting the sounding feedback report.

In an embodiment of the present disclosure, the sounding feedback report frame fed back by the wireless receiver station(s) may further comprise information representative of the channel quality metric determined by the wireless receiver station(s) 120. As already described above, in an embodiment of the present disclosure, the channel quality metric may be the SINR and the information representative of the SINR determined by the wireless receiver station(s) may comprise an explicit value of the SINR and/or a value of the SINR relative to the SNR determined by the wireless receiver station(s) without using interference mitigation.

As will be appreciated, the value of the SINR, e.g. PPSINR measured by each wireless receiver station 120 depends on the determination mode, e.g. the detector being used. In an embodiment of the present disclosure, where the wireless receiver station 120 is configured to implement a MVDR detector, more specifically a MVDR demodulator, the measured PPSINR is given by h+C⁻¹y.

However, in an embodiment of the present disclosure, wherein the wireless receiver station 120 is configured to implement an MRC detector, more specifically an MRC demodulator, the interference is ignored (essentially treating interference as a component of the (colored) noise) resulting in a lower value PPSINR that does not take into account any application of interference mitigation and that may be expressed as:

$$\frac{{‖ h ‖}^{4}}{h * C h} .$$

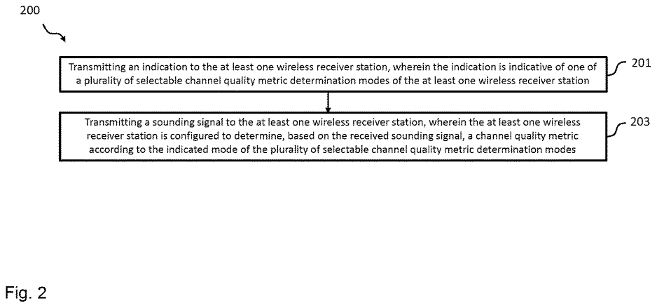

FIG. 2 shows a flow diagram illustrating steps of a method 200 of operating the wireless transmitter station 110 according to an embodiment of the present disclosure. The method 200 comprises a step 201 of transmitting an indication to the at least one wireless receiver station 120, wherein the indication is indicative of one of a plurality of selectable channel quality metric determination modes of the at least one wireless receiver station 120. Moreover, the method comprises a step 203 of transmitting a sounding signal to the at least one wireless receiver station 120, wherein the at least one wireless receiver station 120 is configured to determine, based on the sounding signal, a channel quality metric according to the indicated, i.e. selected channel quality metric determination mode of the plurality of selectable channel quality metric determination modes, as indicated by the indication of step 201.

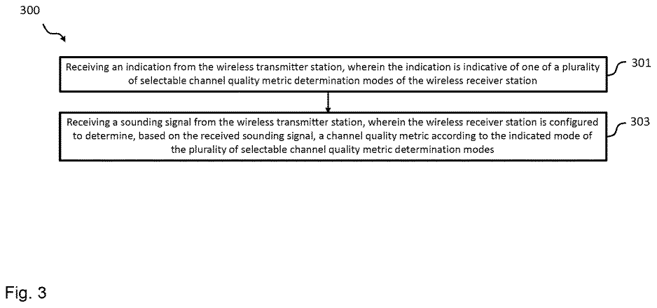

FIG. 3 shows a flow diagram illustrating steps of a method 300 of operating a wireless receiver station 120 according to an embodiment of the present disclosure. The method 300 comprises a step 301 of receiving an indication from the wireless transmitter station, wherein the indication is indicative of one of a plurality of selectable channel quality metric determination modes of the wireless receiver station 120. Moreover, the method 300 comprises a step 303 of receiving a sounding signal from the wireless transmitter station 110. As already described above, the wireless receiver station 120 is configured to determine, based on the sounding signal, a channel quality metric according to the indicated, i.e. selected channel quality metric determination mode of the plurality of selectable channel quality metric determination modes, as indicated by the indication of step 301.

The person skilled in the art will understand that the “blocks” (“units”) of the various figures (method and apparatus) represent or describe functionalities of embodiments of the present disclosure (rather than necessarily individual “units” in hardware or software) and thus describe equally functions or features of apparatus embodiments as well as method embodiments (unit=step).

In the several embodiments provided in the present disclosure, it should be understood that the disclosed system, apparatus, and method may be implemented in other manners. For example, the described embodiment of an apparatus is merely exemplary. For example, the unit division is merely logical function division and may be another division in an actual implementation. For example, a plurality of units or components may be combined or integrated into another system, or some features may be ignored or not performed. In addition, the displayed or discussed mutual couplings or direct couplings or communication connections may be implemented by using some interfaces. The indirect couplings or communication connections between the apparatuses or units may be implemented in electronic, mechanical, or other forms.

The units described as separate parts may or may not be physically separate, and parts displayed as units may or may not be physical units, may be located in one position, or may be distributed on a plurality of network units. Some or all of the units may be selected according to actual needs to achieve the objectives of the solutions of the embodiments of the present disclosure. In addition, functional units in the embodiments of the present disclosure may be integrated into one processing unit, or each of the units may exist alone physically, or two or more units are integrated into one unit.

1. A wireless transmitter station for communication with at least one wireless receiver station over a wireless communication channel in a wireless communication network, wherein the wireless transmitter station is configured to:
transmit a sounding signal to the at least one wireless receiver station, wherein the at least one wireless receiver station is configured to determine, based on the sounding signal, a channel quality metric according to a plurality of determination modes; and
transmit an indication to the at least one wireless receiver station, wherein the indication is indicative of one of the plurality of determination modes of the at least one wireless receiver station.

2. The wireless transmitter station of claim 1, wherein according to a first determination mode of the plurality of determination modes the at least one wireless receiver station is configured to determine the channel quality metric without using interference mitigation, and wherein according to a second determination mode of the plurality of determination modes the at least one wireless receiver station is configured to determine the channel quality metric using the interference mitigation, wherein the indication is indicative of the first determination mode or the second determination mode.

3. The wireless transmitter station of claim 1, wherein the channel quality metric is a Signal to Noise Ratio (SNR) or a Signal to Interference and Noise Ratio (SINR).

4. The wireless transmitter station of claim 1, wherein the wireless transmitter station is further configured to transmit a Sounding null data physical layer protocol data unit (PPDU) (NDP) and an NDP announcement (NDPA) frame to the at least one wireless receiver station, wherein the Sounding NDP comprises the sounding signal, and wherein the NDPA frame comprises the indication.

5. The wireless transmitter station of claim 1, wherein the wireless transmitter station is further configured to receive a sounding feedback report frame from a plurality of wireless receiver stations of the wireless communication network, wherein the sounding feedback report frame received from a specific wireless receiver station of the plurality of wireless receive stations comprises a further indication indicative of the determination mode used by the at least one wireless receiver station for determining the channel quality metric.

6. The wireless transmitter station of claim 5, wherein the reception of the sounding feedback report frame from more than a single wireless receiver station of the plurality of wireless receiver stations is preceded by a trigger frame soliciting the reception of the sounding feedback report frame from two or more specific wireless receiver stations of the plurality of wireless receiver stations.

7. The wireless transmitter station of claim 6, wherein the sounding feedback report frame further comprises information representative of the channel quality metric determined by the at least one wireless receiver station.

8. The wireless transmitter station of claim 7, wherein the channel quality metric is a Signal to Interference and Noise Ratio, (SINR), and wherein the information comprises an explicit value of the SINR and/or a value of the SINR relative to a signal-to-noise-ratio, (SNR) determined by the at least one wireless receiver station, wherein the at least one wireless receiver station is further configured to determine the SNR without using interference mitigation.

9. A wireless receiver station for communication with a wireless transmitter station over a wireless communication channel in a wireless communication network, wherein the wireless receiver station is configured to:
receive a sounding signal from the wireless transmitter station;
determine, based on the sounding signal, a channel quality metric according to a plurality of determination modes; and
receive an indication from the wireless transmitter station, wherein the indication is indicative of one of the plurality of determination modes.

10. The wireless receiver station of claim 9, wherein according to a first determination mode of the plurality of determination modes the wireless receiver station is further configured to determine the channel quality metric without using interference mitigation, and wherein according to a second determination mode of the plurality of determination modes the wireless receiver station is further configured to determine the channel quality metric using the interference mitigation, wherein the indication is indicative of the first determination mode or the second determination mode.

11. The wireless receiver station of claim 10, wherein according to the first determination mode the wireless receiver station is further configured to determine the channel quality metric without using the interference mitigation by using a maximal ratio combining (MRC) detector.

12. The wireless receiver station of claim 10, wherein according to the second determination mode the wireless receiver station is further configured to determine the channel quality metric using the interference mitigation by using a minimum variance distortionless response (MVDR) detector.

13. The wireless receiver station of claim 10, wherein the wireless receiver station comprises a plurality of receiving antennas and wherein according to the second determination mode the wireless receiver station is further configured to determine the channel quality metric using the interference mitigation by using a reduced number of the plurality of receiving antennas.

14. The wireless receiver station of claim 13, wherein the channel quality metric is a Signal to Noise Ratio (SNR) or a Signal to Interference and Noise Ratio (SINR).

15. The wireless receiver station of claim 13, wherein the wireless receiver station is further configured to receive a Sounding null data physical layer protocol data unit (PPDU) (NDP) and an NDP announcement (NDPA) frame from the wireless transmitter station, wherein the Sounding NDP comprises the sounding signal and wherein the NDPA frame comprises the indication.

16. The wireless receiver station of claim 9, wherein the wireless receiver station is further configured to transmit a sounding feedback report frame to the wireless transmitter station, wherein the sounding feedback report frame comprises a further indication indicative of the determination mode used by the wireless receiver station for determining the channel quality metric.

17. The wireless receiver station of claim 16, wherein the wireless receiver station is further configured to transmit the sounding feedback report frame to the wireless transmitter station, in response to receiving from the wireless transmitter station a trigger frame soliciting the transmission of the sounding feedback report frame from two or more specific wireless receiver stations of a plurality of wireless receiver stations of the wireless communication network.

18. The wireless receiver station of claim 16, wherein the sounding feedback report frame comprises a multiple input multiple output (MIMO) control field, and wherein the MIMO control field comprises the further indication.

19. A method of operating a wireless receiver station for communication with a wireless transmitter station over a wireless communication channel in a wireless communication network, the method comprising:
receiving an indication from the wireless transmitter station, wherein the indication is indicative of one of a plurality of determination modes;
receiving a sounding signal from the wireless transmitter station; and
determining, based on the sounding signal, a channel quality metric according to the indicated determination mode of the plurality of determination modes.

20. The method of claim 19, wherein the channel quality metric is a Signal to Noise Ratio (SNR) or a Signal to Interference and Noise Ratio (SINR).
